(19) United States
(12) Patent Application Publication
(10) Pub. No.: US 2009/0276065 A1
(43) Pub. Date: Nov. 5, 2009

(54) VEHICLE AUDIO SYSTEM FOR CONNECTING PORTABLE SOUND GENERATING DEVICE AND METHOD FOR OPERATING THE SAME

(76) Inventor: Si Ho Yoo, Seongnam-si (KR)

Correspondence Address: MORGAN, LEWIS & BOCKIUS LLP (SF), One Market, Spear Street Tower, Suite 2800, San Francisco, CA, 94105, US

(21) Appl. No.: 11/950,235

(22) Filed: Dec. 4, 2007

(30) Foreign Application Priority Data
Dec. 7, 2006 (KR) 10-2006-0123696

(51) Int. Cl. G06F 17/00

(52) U.S. Cl. 700/94

(57) ABSTRACT

An audio system and methods of its use. The system includes a jack with both an AUX port and a USB port. An interface unit electrically connects the jack to the system, transmits a control signal from the system to an external device connected to the jack, and transmits output signals and music information from the external device to the system. The interface unit may include a decoder and an analog multiplexer. A user-operable mode selection device and a controller may further be provided. The controller detects a mode input by a user to the mode selection device and changes the mode of the system into AUX mode, USB mode, or CD mode. The controller may also receive a signal indicative of whether a USB device, an MP3 player, or an iPod® is connected to the jack, and turn on one a USB, an MP3, or an iPod® indicator.

### CROSS-REFERENCE TO RELATED APPLICATION

This application claims priority to, and the benefit of, Korean Patent Application No. 10-2006-0123696, filed on Dec. 7, 2006, the entire disclosure of which is hereby incorporated by reference.

### BACKGROUND OF THE INVENTION

1. Field of the Invention

The present invention relates to a vehicle audio system that can have an external portable sound generating device connected thereto, and a method for operating the same.

2. Description of Related Art

Consumer demand for vehicle audio systems that can play MP3, WMA, OGG, and similar formats is increasing. Systems that can connect to USB devices or iPods® have been developed; however, each system typically only communicates with one type of external device.

Alternatively, an external sound generating device can be connected through an AUX terminal of the audio system. However, this can only output sounds from the external sound generating device. The external device cannot be controlled through the system, so track skipping, start, stop, file information display, etc. must be carried out on the device itself.

### SUMMARY OF THE INVENTION

Exemplary embodiments of the present invention provide an audio system, including a jack with both an AUX port and a USB port. An interface unit electrically connects the jack to the system, transmits a control signal from the system to an external device connected to the jack, and transmits output signals and music information from the external device to the system. The interface unit may include a decoder and an analog multiplexer.

A user-operable mode selection device and a controller may further be provided. The controller detects a mode input by a user to the mode selection device and changes the mode of the system into an AUX mode, a USB mode, or a CD mode. The controller may also receive a signal indicative of whether a USB device, an MP3 player, or an iPod® is connected to the jack, and turn on one of a USB, an MP3, or an iPod® indicator.

Embodiments of the present invention also provide methods of operating an audio system, the system including a user-interface module, a jack with both a USB port and an AUX port, and an interface unit electrically connecting the jack to the system.

The method may include connecting an iPod® to the USB port and the AUX port using a dedicated cable; performing, at the iPod®, a decoding operation; transmitting music information of the iPod® to the system through the interface unit via a UART communication; transmitting decoded output signals of the iPod® to the system through the AUX port; generating a control signal corresponding to manipulation of the user interface module; and transmitting the control signal from the system to the iPod® through the interface unit via the UART communication.

Alternatively, the method may include connecting a device to the USB port; transmitting music information of the device to the interface unit; performing, at a decoder of the interface unit, a decoding operation; transmitting decoded music information to the system via a UART communication; generating a control signal corresponding to manipulation of the user interface module; and transmitting the control signal from the system to the device through the interface unit via the UART communication.

Alternatively, the method may include connecting a device to the AUX port; transmitting output signals of the device directly to the system, without passing through the interface unit; and outputting the output signals through a speaker.

### BRIEF DESCRIPTION OF THE DRAWINGS

The above and other features of the present invention will be described with reference to certain exemplary embodiments thereof illustrated the attached drawings, in which:

FIG. 1 is a schematic diagram illustrating the configuration of a vehicle audio system for connecting an external portable sound generating device in accordance with an exemplary embodiment of the present invention;

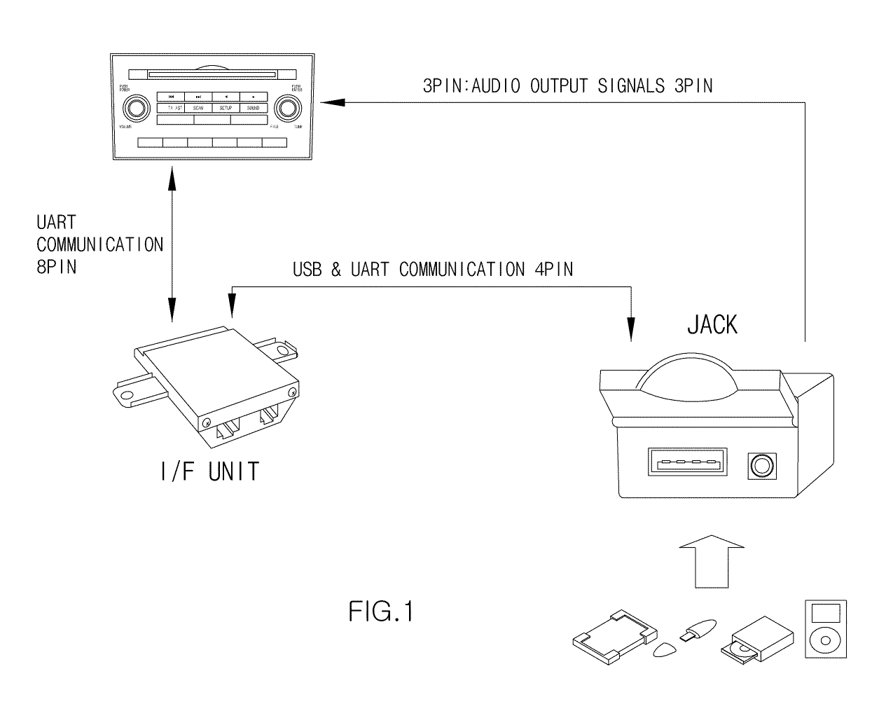

FIG. 2 is a schematic diagram illustrating electrical interconnections of a vehicle audio system in accordance with an exemplary embodiment of the present invention;

FIG. 3 is a schematic diagram illustrating signal processing for an iPod® connected to a vehicle audio system in accordance with an exemplary embodiment of the present invention;

FIG. 4 is a schematic diagram illustrating signal processing for a USB device connected to a vehicle audio system in accordance with an exemplary embodiment of the present invention;

FIG. 5 is a schematic diagram illustrating signal processing for a device connected to an AUX port of a vehicle audio system in accordance with an exemplary embodiment of the present invention;

FIG. 6 is a diagram depicting a user interface of a vehicle audio system in accordance with an exemplary embodiment of the present invention; and

FIG. 7 is a diagram illustrating AUX and USB ports of a vehicle audio system in accordance with an exemplary embodiment of the present invention.

### DETAILED DESCRIPTION OF THE PREFERRED EMBODIMENTS

Hereinafter, exemplary embodiments of the present invention will be described with reference to the accompanying drawings. The exemplary embodiments are provided so that those skilled in the art can sufficiently understand the present invention, but can be modified in various forms and the scope of the present invention is not limited to the exemplary embodiments.

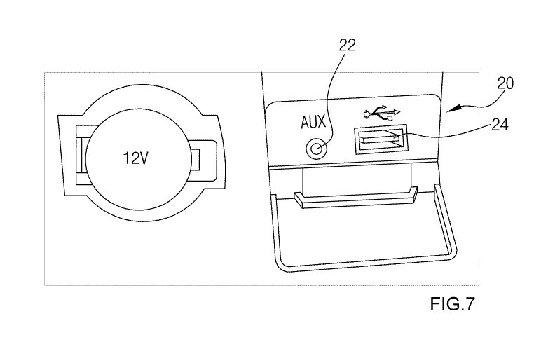

An audio system 10 includes an audio controller 12. A jack 20 is connected to the system 10, and an interface unit 30 acts as a signal transmission medium between the system 10 and the jack 20. As depicted in FIG. 7, the jack 20 includes an AUX port 22 and a USB port 24 so that various kinds of external sound generating devices can be connected to the system 10.

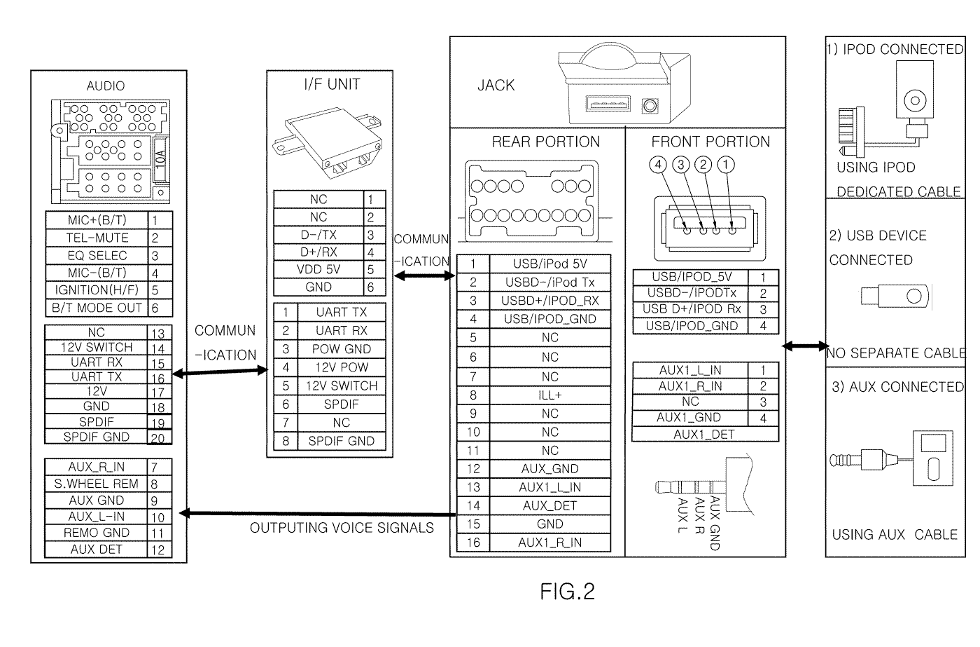

Referring to FIG. 2, the audio system 10 is interconnected with the jack 20 directly, or via the interface unit 30. The jack 20 includes a front panel on which the AUX port 22 and the USB port 24 are provided so that various kinds of external sound generating devices can be connected to the system 10. Provided on the back panel of the jack 20 is a connector via which the jack 20 is electrically connected to the interface unit 30 and the audio system 10. An exemplary pin arrangement of the connector is illustrated in FIG. 2.

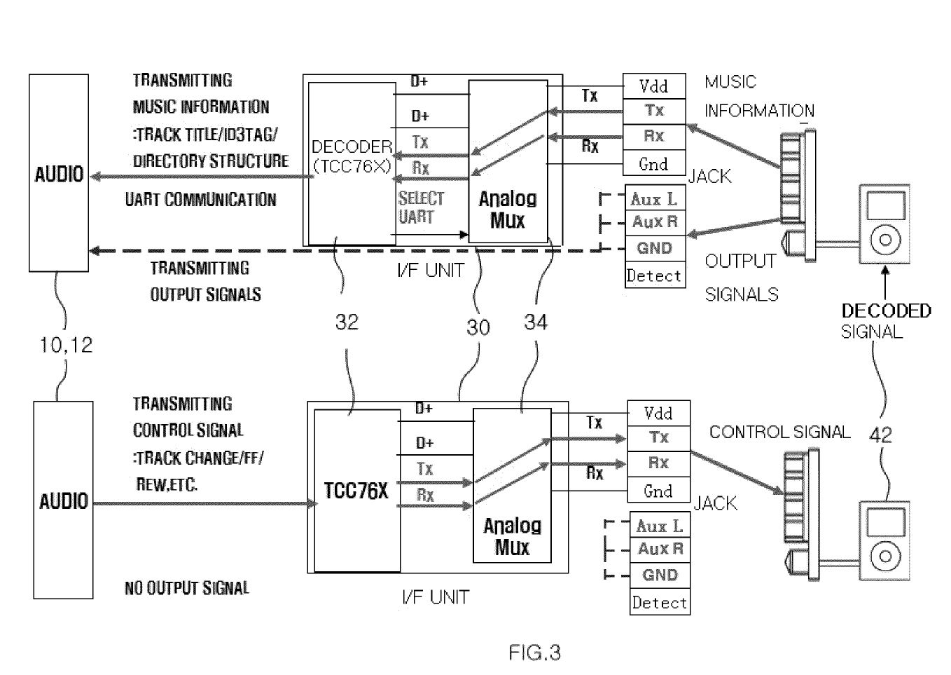

Referring to FIGS. 3-5, the interface unit 30 includes a decoder 32 decoding music information, such as from a USB device 40, an MP3 player 40, etc. An analog multiplexer 34 may be coupled between the jack 20 and the remainder of the audio system 10 to transmit control signals from the system 10 to an external sound generating device connected through the jack 20, and to transmit output signals and music information from the external sound generating device to the system 10.

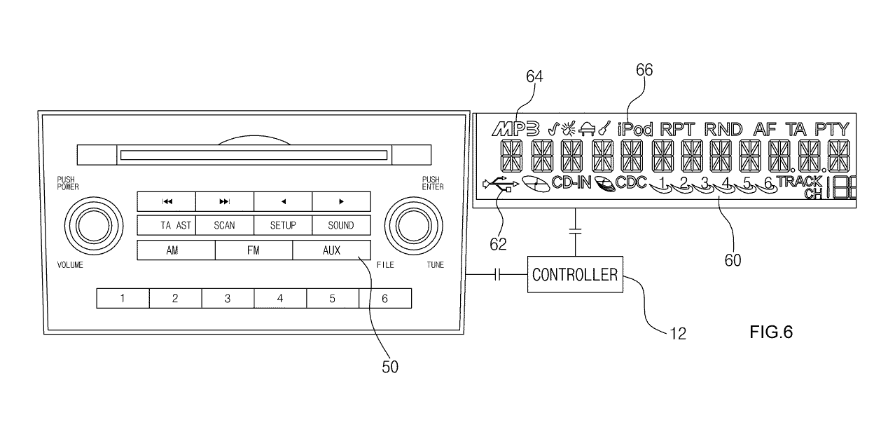

A mode selection button 50 is provided as depicted in FIG. 6. The audio controller 12 detects the pushing time of the mode selection button 50 and selectively changes the execution mode of the system 10 into an AUX mode, a USB mode, or a CD mode. For example, if the mode selection button 50 is pushed and held, the execution mode is changed into the AUX mode, and if the button 50 is pushed briefly, the mode is alternated between the CD mode and USB mode. However, if an MP3 player or USB device is not coupled to the USB port, only the CD mode is used.

Moreover, as depicted in FIG. 6, USB, MP3,iPod® display lamps 62, 64 and 66 are additionally provided, such as in a liquid crystal display 60. The audio controller 12 receives a signal when the USB device, the MP3 player, or the iPod® is connected to the jack 20, and thereby turns on a corresponding one of the display lamps 62, 64 and 66.

Hereinafter, a method for operating the audio system of the above-described exemplary embodiment of the present invention will be described.

First, a method for connecting the iPod® to the jack 20 and operating the same will be described. Referring to FIG. 3, the iPod® 42 is connected to the USB port 24 and the AUX port 22 of the jack 20 using a dedicated cable. The iPod® 42 performs a decoding operation. Accordingly, output signals decoded by the iPod® 42 are transmitted to the system 10 through the AUX port 22 of the jack 20 and output through the vehicle's speakers (not shown). Moreover, music information of the iPod® 42 is transmitted to the system 10 through the interface unit 30, through a UART communication. “Music information” may refer to track title, ID3Tag, directory structure, etc.

Subsequently, if a user controls the functions, e.g., track change, FF, Rew, section repeat, etc., through the system 10, the system 10 transmits the corresponding control signal through the UART communication to the interface unit 30 and from the interface unit 30 to the iPod® 42, such that the iPod® 42 is controlled based on the control signal of the system 10.

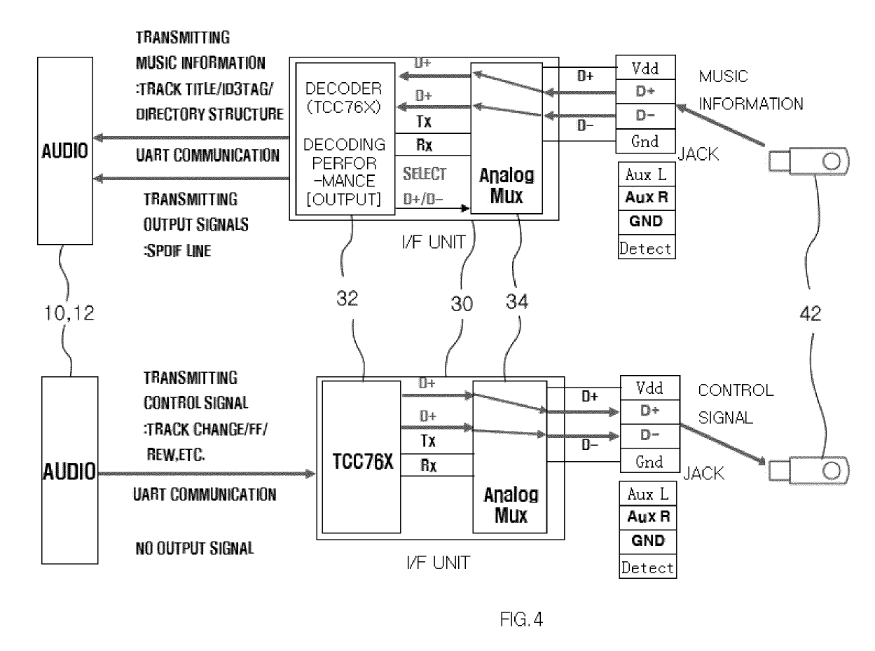

Referring to FIG. 4, a signal processing operation performed when a USB device is connected to the vehicle audio system 10 will be described. First, the USB device or MP3 player 40 is connected to the USB port 24 of the jack 20. Music information of the USB device 40 or the MP3 player 40 is transmitted to the interface unit 30, and decoding is performed in the decoder 32 of the interface unit 30. The decoded music information (e.g. track title, ID3tag, directory structure) and the output signals are transmitted to the system 10 through the UART communication. The system 10 outputs the output signals received through the UART communication to the vehicle's speakers.

If the user controls the functions, e.g., track change, FF, Rew, section repeat, etc., through the system 10, the system 10 transmits the corresponding control signal through the UART communication to the interface unit 30, and from the interface unit 30 to the USB device 40 or the MP3 player 40. Accordingly, the USB device 40 or the MP3 player 40 performs the command (track change, FF, Rew, section repeat, etc.) based on the control signal of the system 10.

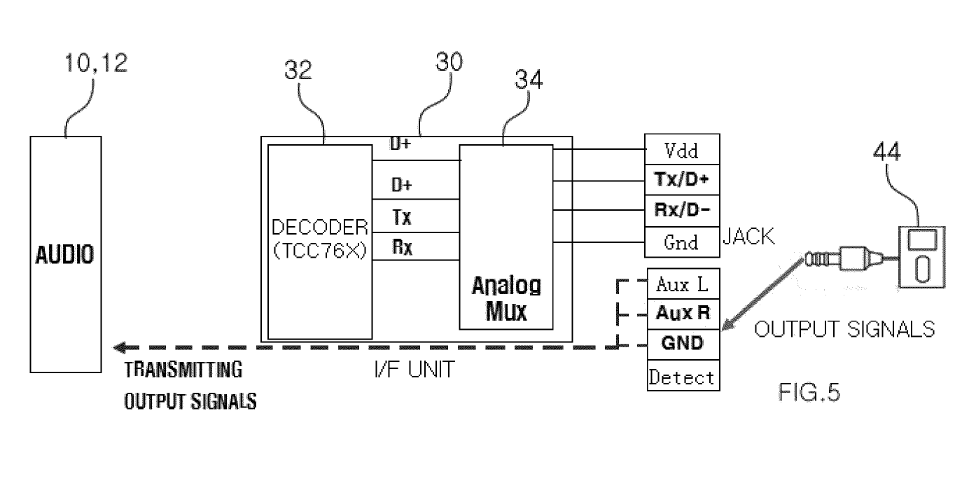

Now, a method for connecting an AUX device, such as a CD player, to the jack 20 and operating the same will be described. Referring to FIG. 5, the AUX device 44 is connected to the AUX port 22 of the jack 20. Since the AUX device 44 does not require a separate decoding operation, its output signals are directly transmitted to the system 10, without passing through the interface unit 30. Since control of the AUX device 44 is not available through the vehicle audio system 10, the system 10 outputs the signals through the speakers only.

While exemplary embodiments of the present invention have been described and illustrated, the present invention is not limited thereto. On the contrary, it should be understood that various modifications and variations of the present invention can be made by those skilled in the art without departing from the spirit and the technical scope of the present invention as defined by the appended claims.

What is claimed is:

1. An audio system, comprising:
a jack comprising an AUX port and a USB port; and
an interface unit, electrically connecting the jack to the system, for transmitting a control signal from the system to an external sound generating device connected to the jack, and for transmitting output signals and music information from the external sound generating device to the system.

2. The system of claim 1, wherein the interface unit comprises a decoder and an analog multiplexer.

3. The system of claim 1, further comprising a user-operable mode selection device, and a controller for detecting a mode input by a user to the mode selection device and thereby selectively changing a mode of the system into one of an AUX mode, a USB mode, and a CD mode.

4. The system of claim 3, wherein the controller receives a signal indicative of whether a USB device, an MP3 player, or an iPod® is connected to the jack, and thereby turns on one of a USB, an MP3, and an iPod® indicator.

5. A method of operating an audio system, the system comprising a user-interface module, a jack comprising a USB port and an AUX port, and an interface unit electrically connecting the jack to the system, the method comprising:
connecting an iPod® to the USB port and the AUX port using a dedicated cable;
performing, at the iPod®, a decoding operation;
transmitting music information of the iPod® to the system through the interface unit via a UART communication;
transmitting decoded output signals of the iPod® to the system through the AUX port;
if a user manipulates the user interface module, generating a control signal corresponding to the manipulation; and
transmitting the control signal from the system to the iPod® through the interface unit via the UART communication.

6. A method of operating an audio system, the system comprising a user-interface module, a jack comprising a USB port, and an interface unit electrically connecting the jack to the system, the method comprising:
connecting a device to the USB port;
transmitting music information of the device to the interface unit;
performing, at a decoder of the interface unit, a decoding operation;
transmitting decoded music information to the system via a UART communication;
if a user manipulates the user-interface module, generating a control signal corresponding to the manipulation; and
transmitting the control signal from the system to the device through the interface unit via the UART communication.

7. A method of operating an audio system, the system comprising a jack comprising an AUX port communicating with the system through an interface unit, the method comprising:
connecting a device to the AUX port;
transmitting output signals of the device directly to the system, without passing through the interface unit; and
outputting the output signals through a speaker.
